(19) United States
(12) Patent Application Publication
(10) Pub. No.: US 2022/0153139 A1
(43) Pub. Date: May 19, 2022

(54) SYSTEM AND METHOD FOR EXTENDING A RANGE OF AN ELECTRIC VEHICLE

(71) Applicant: LOG 9 MATERIALS SCIENTIFIC PRIVATE LIMITED, BENGALURU (IN)

(72) Inventors: AKSHAY VIVEK SINGHAL, DEOBAND (IN); ANSHUL KUMAR SHARMA, KANGRA (IN); ANUJ JAIN, ROHTAK (IN); ANKUSH RAINA, JAMMU TAWI (IN); HEMANT CHARAYA, HISAR (IN)

(21) Appl. No.: 17/347,524

(22) PCT Filed: Dec. 16, 2019
(86) PCT No.: PCT/IN2019/050924

§ 371 Date: Jun. 14, 2021

(30) Foreign Application Priority Data
Dec. 15, 2018 (IN) 201811043055

(51) Int. Cl. B60L 1/00; B60W 30/18; H01M 10/42; H01M 10/48

(52) U.S. Cl. CPC B60L 1/20; B60W 30/18127; H01M 10/484; H01M 10/4242; H01M 10/4214

(57) ABSTRACT

A system for extending a range of an electric vehicle includes a graphene-based metal-air battery system (GMABS), an electrolyte management system (EMS), a flow management system (FMS), one or more auxiliary power sources, and a real-time monitoring and feedback system (RMS). The GMABS includes multiple cells electrically connected to each other and filled with an electrolyte for initiating a reaction to generate power. The EMS regulates a temperature of the electrolyte flowing through the cells. The FMS regulates a circulation of the electrolyte in the GMABS. At least one auxiliary power source is connected to the GMABS to receive and deliver the power to components of the electric vehicle. The RMS continuously computes and monitors a state of charge of each auxiliary power source in real time to facilitate a continuous power delivery to the electric vehicle, thereby extending the range of the electric vehicle.

### CROSS-REFERENCE TO RELATED APPLICATIONS

The present application is a National Phase application of the PCT application with the serial number PCT/IN2019/050924 filed on Dec. 16, 2019 with the title, “SYSTEM AND METHOD FOR EXTENDING A RANGE OF AN ELECTRIC VEHICLE”. The embodiments herein claim the priority of the Indian Provisional Patent Application with serial number 201811043055, filed on Nov. 15, 2018, with the title “SYSTEM ARCHITECTURE FOR RANGE EXTENSION OF ELECTRIC VEHICLES USING GRAPHENE BASED METAL-AIR BATTERY”, and subsequently post-dated by 1 month to Dec. 15, 2018. The content of the Provisional patent application is incorporated in its entirety by reference herein.

### BACKGROUND

### Technical Field

The embodiments herein are generally related to the field of electric vehicles. The embodiments herein are generally related to the field of electric vehicles powered by metal-air batteries. The embodiments herein are more particularly related to a system and a method for extending a range of an electric vehicle by using a graphene-based metal-air battery.

### Description of the Related Art

The alarming signs of climate change due to human activities have never been more apparent. Large-scale emissions of greenhouse gases into the environment are one of the reasons for a continuous rise in global temperatures. A major portion of these greenhouse gases arises from the transportation sector which accounts for about 14% of the total emissions. Therefore, in the pursuit of environmental protection, there is a need for reducing these emissions by using vehicles driven by electricity instead of combustion engines.

Although electric vehicles (EVs) have been on the scene for quite a few years, they still account for a very small market share. In the early years, electric vehicles were not an attractive option for consumers due to their high cost in comparison to conventional vehicles. Over the years, due to the advancement in battery technology and full-scale commercialization of lithium-ion (Li-ion) batteries, the cost of electric vehicles has significantly reduced to match the scale of conventional vehicles. However, in spite of cost-cutting and advancing battery technology, electric vehicles are still struggling to penetrate the market due to their limited driving range and long charging times. The highest range covered by an electric vehicle in a single charge is, for example, about 450 kilometres (km). However, this high range is implemented in upscale electric vehicle models such as those manufactured by Tesla, Inc., that expensive and run on top-of-the-line Li-ion batteries. On average, the range for most electric vehicles still hovers from about 100 km to 150 km before they are needed to be charged again.

One method to resolve the issue of the low range of an electric vehicle is through developing and using batteries having high energy density. Hence, there is a need for a system and a method that extends the range of an electric vehicle by employing a high energy density graphene-based metal-air battery. Moreover, there is a need for optimizing a power generation reaction within the graphene-based metal-air battery installed in the electric vehicle. Furthermore, there is a need for continuously computing and monitoring a state of charge of auxiliary power sources operably connected to the graphene-based metal-air battery in real time to facilitate a continuous delivery of the power to components of the electric vehicle.

The above-mentioned shortcomings, disadvantages, and problems are addressed herein and will be understood by reading and studying the following specification.

### OBJECTIVES OF THE EMBODIMENTS

The primary object of the embodiments herein is to provide a system and a method for extending a range of an electric vehicle by using a graphene-based metal-air battery.

Another object of the embodiments herein is to provide a graphene-based metal-air battery system (GMABS) comprising a plurality of cells that are electrically connected to each other and configured to be filled with an electrolyte for initiating a reaction in the graphene-based metal-air battery system to generate power.

Yet another object of the embodiments herein is to provide a flow management system for regulating a circulation of the electrolyte in the GMABS, controlling a flow of the electrolyte in the GMABS, and facilitating a uniform distribution of the electrolyte in the cells of the GMABS.

Yet another object of the embodiments herein is to provide an electrolyte management system for regulating and maintaining a temperature of the electrolyte flowing through the cells of the GMABS in a range, for example, from about 10 degree Celsius to about 80 degree Celsius, during the reaction, and for purifying and freeing the electrolyte from impurities that interfere with the reaction in the GMABS.

Yet another object of the embodiments herein is to provide a single auxiliary power source operably connected to the GMABS for receiving the power from the GMABS and delivering the received power to components of the electric vehicle.

Yet another object of the embodiments herein is to provide a plurality of auxiliary power sources, where any one of the auxiliary power sources receives the power from the GMABS when another one of the auxiliary power sources is discharged to a predefined state of charge (SoC), and delivers the received power to components of the electric vehicle.

Yet another object of the embodiments herein is to provide a real-time monitoring and feedback system comprising one or more feedback sensors for regulating a plurality of parameters, for example, temperature, flow, power, energy, etc., within the electric vehicle and continuously computing and monitoring the SoC of each of the auxiliary power sources in real time to facilitate a continuous delivery of the power to the components of the electric vehicle by any one of the auxiliary power sources, thereby extending the range of the electric vehicle.

Yet another object of the embodiments herein is to provide a display unit for projecting real-time values of the plurality of parameters regulated by the feedback sensors positioned in the real-time monitoring and feedback system.

Yet another object of the embodiments herein is to provide a regenerative braking system for recapturing a kinetic energy of the electric vehicle for charging at least one of the auxiliary power sources during braking.

Yet another object of the embodiments herein is to provide one or more buffer tanks for storing additional quantities of the electrolyte and replenishing the electrolyte in the cells of the GMABS to a predefined composition.

Yet another object of the embodiments herein is to provide a mechanical refuelling system for retracting metal consumed during the reaction in the GMABS and inserting units containing metal into the cells of the GMABS.

Yet another object of the embodiments herein is to provide an overflow management system for preventing a leakage of the electrolyte inside the electric vehicle.

Yet another object of the embodiments herein is to provide a temperature control unit, also referred to as a “heating-cooling system”, for controlling the temperature of the electrolyte flowing through the cells of the GMABS.

Yet another object of the embodiments herein is to provide a hydrogen harvesting system, also referred to as a “hybrid system”, for collecting and storing a hydrogen gas produced during the reaction in the GMABS.

Yet another object of the embodiments herein is to provide a hydrogen harvesting system comprising a hydrogen fuel cell for operating on the hydrogen gas and providing power for charging the auxiliary power sources.

Yet another object of the embodiments herein is to provide a graphene-based air conditioning system for providing a desired air composition for an operation of the cells of the GMABS.

Yet another object of the embodiments herein is to provide a switching unit configured as an electronic circuit, in operable communication with the real-time monitoring and feedback system, for selectively switching between the auxiliary power sources for delivering the power to the components of the electric vehicle based on the computed SoC of each of the auxiliary power sources.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating embodiments and numerous specific details thereof, are given by way of illustration and not of limitation. Many changes and modifications may be made within the scope of the embodiments herein without departing from the scope and spirit thereof, and the embodiments herein include all such modifications.

This summary is provided to introduce a selection of concepts in a simplified form that are further disclosed in the detailed description. This summary is not intended to determine the scope of the claimed subject matter.

The embodiments herein provide a system and a method for extending a range of an electric vehicle by using a graphene-based metal-air battery. Moreover, the embodiments herein optimize a power generation reaction within the graphene-based metal-air battery by purifying the electrolyte, uniformly distributing the electrolyte in the cells of the graphene-based metal-air battery, replenishing the electrolyte, regulating a flow of the electrolyte within the graphene-based metal-air battery, regulating and maintaining a temperature of an electrolyte flowing through cells of the graphene-based metal-air battery, and replenishing metal contained in the graphene-based metal-air battery. Furthermore, the embodiments herein continuously compute and monitor a state of charge (SoC) of auxiliary power sources operably connected to the graphene-based metal-air battery in real time to facilitate a continuous delivery of the power to components of the electric vehicle. The embodiments herein solve the long-standing technical issue of a low range of electric vehicles and provide a substitute to conventional vehicles.

According to one embodiment herein, the system comprises a graphene-based metal-air battery system (GMABS), a flow management system, an electrolyte management system, one or more of a plurality of auxiliary power sources, and a real-time monitoring and feedback system. The GMABS comprises a plurality of cells electrically connected to each other and configured to be filled with an electrolyte for initiating a reaction in the GMABS to generate power. The GMABS is selected from the group consisting of an aluminium-air battery, a zinc-air battery, a lithium-air battery, and an iron-air battery. The flow management system is operably connected to the GMABS. The flow management system is configured to regulate a circulation of the electrolyte in the GMABS. According to an embodiment herein, the flow management system comprises one or more pumps configured to control a flow of the electrolyte in the GMABS. According to another embodiment herein, the flow management system comprises one or more rotameters integrated with one or more valves. The rotameters are configured to facilitate a uniform distribution of the electrolyte in the plurality of cells of the GMABS. According to another embodiment herein, the flow management system comprises one or more distribution channels for distributing the electrolyte through the plurality of cells of the GMABS. According to another embodiment herein, the flow management system comprises an overflow management system configured to prevent a leakage of the electrolyte inside the electric vehicle.

According to one embodiment herein, the electrolyte management system is in operable communication with the flow management system. The electrolyte management system is configured to regulate and maintain a temperature of the electrolyte flowing through the plurality of cells of the GMABS during the reaction. According to an embodiment herein, a temperature control unit, also referred to as a “heating-cooling system”, is operably coupled to the electrolyte management system. The temperature control unit is configured to control the temperature of the electrolyte flowing through the plurality of cells of the GMABS. According to an embodiment herein, the electrolyte management system comprises one or more filters configured to purify and free the electrolyte from impurities that interfere with the reaction in the GMABS.

According to one embodiment herein, at least one of the plurality of auxiliary power sources is operably connected to the GMABS. The plurality of auxiliary power sources is selected from the group consisting of a metal ion battery, a lead acid battery, a nickel-cadmium battery, a redox flow battery, a supercapacitor, a nickel metal hydride battery, a zinc-bromine battery, a polysulfide-bromide battery, and any combination thereof. Any one of the plurality of auxiliary power sources is configured to receive the power from the GMABS when another one of the plurality of auxiliary power sources is discharged to a predefined SoC. Any one of the plurality of auxiliary power sources is configured to deliver the received power to components of the electric vehicle. According to an embodiment herein, a single auxiliary power source is operably connected to the GMABS for receiving the power from the GMABS and delivering the received power to components of the electric vehicle. According to an embodiment herein, the system comprises a switching unit, in operable communication with the real-time monitoring and feedback system, for selectively switching between the plurality of auxiliary power sources for delivering the power to the components of the electric vehicle based on the computed SoC of each of the plurality of auxiliary power sources.

According to one embodiment herein, the real-time monitoring and feedback system comprises one or more feedback sensors configured to regulate a plurality of parameters comprising, for example, temperature, flow, power, energy, etc., within the electric vehicle. According to an embodiment herein, the system comprises a display unit operably coupled to the real-time monitoring and feedback system for projecting real-time values of the plurality of parameters regulated by the feedback sensors positioned in the real-time monitoring and feedback system. According to an embodiment herein, the real-time monitoring and feedback system is configured to continuously compute and monitor a SoC of each of the plurality of auxiliary power sources in real time to facilitate a continuous delivery of the power to the components of the electric vehicle by any one of the plurality of auxiliary power sources, thereby extending the range of the electric vehicle.

According to one embodiment herein, the system comprises a regenerative braking system operably connected to the plurality of auxiliary power sources. The regenerative braking system is configured to recapture a kinetic energy of the electric vehicle for charging at least one of the plurality of auxiliary power sources during braking. According to an embodiment herein, the system comprises one or more buffer tanks operably connected to the GMABS. The buffer tanks are configured to store additional quantities of the electrolyte and replenish the electrolyte in the plurality of cells of the GMABS to a predefined composition. According to an embodiment herein, the system comprises a mechanical refuelling system configured to retract metal consumed during the reaction in the GMABS and insert units containing metal into the plurality of cells of the GMABS. According to an embodiment herein, the system comprises a hydrogen harvesting system, also referred to as a “hybrid system”, operably coupled to the GMABS. The hydrogen harvesting system is configured to collect and store a hydrogen gas produced during the reaction in the GMABS. According to an embodiment herein, the hydrogen harvesting system comprises a hydrogen fuel cell configured to operate on the hydrogen gas and provide power for charging any one of the plurality of auxiliary power sources. According to an embodiment herein, the system comprises a graphene-based air conditioning system configured to provide a desired air composition for an operation of the plurality of cells of the GMABS.

According to one embodiment herein, a method for extending a range of an electric vehicle is disclosed. In the method disclosed herein, a GMABS comprising a plurality of cells as disclosed above is installed in the electric vehicle. The flow management system operably connected to the GMABS circulates the electrolyte in the GMABS to fill the plurality of cells of the GMABS. The electrolyte filled in the plurality of cells of the GMABS initiates a reaction in the GMABS to generate power. The electrolyte management system, in operable communication with the flow management system, regulates and maintains a temperature of the electrolyte flowing through the plurality of cells of the GMABS during the reaction. The switching unit selectively connects one of the plurality of auxiliary power sources to the GMABS to receive the power from the GMABS when another one of the plurality of auxiliary power sources is discharged to a predefined SoC. The connected auxiliary power source delivers the received power to components of the electric vehicle. The real-time monitoring and feedback system continuously computes and monitors the SoC of each of the plurality of auxiliary power sources in real time to facilitate a continuous delivery of the power to the components of the electric vehicle by any one of the plurality of auxiliary power sources, thereby extending the range of the electric vehicle. Furthermore, in the method disclosed herein, the regenerative braking system, the buffer tanks, the mechanical refuelling system, the pumps and rotameters of the flow management system, the overflow management system, the temperature control unit, the filters of the electrolyte management system, the hydrogen harvesting system, and the graphene-based air conditioning system perform their respective functions as disclosed above during the operation of the GMABS.

According to one embodiment herein, related systems comprise circuitry and/or programming for effecting the methods disclosed herein. According to an embodiment herein, the circuitry and/or programming are any one of a combination of hardware, software, and/or firmware configured to execute the methods disclosed herein depending upon the design choices of a system designer. According to an embodiment herein, various structural elements are employed depending on the design choices of the system designer.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the embodiments and the accompanying drawings in which:

FIG. 1 illustrates a block diagram of a system for extending a range of an electric vehicle using a graphene-based metal-air battery system, according to one embodiment herein.

FIG. 2 illustrates a temperature control unit incorporated in the system, according to one embodiment herein.

FIG. 3 illustrates a block diagram of a regenerative braking system incorporated in the system, according to one embodiment herein.

FIG. 4 illustrates a top perspective, cutaway view of an electric vehicle, showing an installation of the graphene-based metal-air battery system and other components of the system, according to one embodiment herein.

FIGS. 5A-5B together illustrate perspective views of a mechanical refuelling system incorporated in the system, according to one embodiment herein;

FIGS. 6A-6B together illustrate operations of the graphene-based metal-air battery system in operable communication with two auxiliary power sources for powering a load, according to one embodiment herein.

FIGS. 7A-7B together illustrates operations of the graphene-based metal-air battery system in operable communication with a single auxiliary power source for powering a load, according to one embodiment herein.

FIG. 8 illustrates a flowchart comprising the steps of the method for extending a range of an electric vehicle, according to one embodiment herein.

FIGS. 9A-9B together illustrate a flowchart comprising the steps of a method implemented by the real-time monitoring and feedback system for computing a state of charge of each of the auxiliary power sources of the system, according to one embodiment herein.

Although the specific features of the embodiments herein are shown in some drawings and not in others. This is done for convenience only as each feature may be combined with any or all of the other features in accordance with the embodiments herein.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that logical, mechanical, and other changes may be made without departing from the scope of the embodiments. The following detailed description is therefore not to be taken in a limiting sense.

The embodiments herein provide a system and a method for extending a range of an electric vehicle by using a graphene-based metal-air battery. As used herein, “electric vehicle” refer to an all-electric vehicle, a plug-in hybrid vehicle, a hybrid vehicle that has multiple propulsion sources out of which one is an electric drive system. According to an embodiment herein, the system comprises a graphene-based metal-air battery system (GMABS), a flow management system, an electrolyte management system, one or more of a plurality of auxiliary power sources, and a real-time monitoring and feedback system.

According to one embodiment herein, the GMABS comprises a plurality of cells. The plurality of cells is electrically connected to each other and configured to be filled with an electrolyte for initiating a reaction in the GMABS to generate power.

According to one embodiment herein, the GMABS is selected from the group consisting of an aluminium-air battery, a zinc-air battery, a lithium-air battery, and an iron-air battery.

According to one embodiment herein, the flow management system is operably connected to the GMABS. The flow management system is configured to regulate a circulation of the electrolyte in the GMABS.

According to one embodiment herein, the flow management system comprises one or more pumps configured to control a flow of the electrolyte in the GMABS.

According to one embodiment herein, the flow management system comprises one or more rotameters integrated with one or more valves. The rotameters are configured to facilitate a uniform distribution of the electrolyte in the plurality of cells of the GMABS.

According to one embodiment herein, the flow management system comprises one or more distribution channels for distributing the electrolyte through the plurality of cells of the GMABS.

According to one embodiment herein, the flow management system comprises an overflow management system configured to prevent a leakage of the electrolyte inside the electric vehicle.

According to one embodiment herein, the electrolyte management system is in operable communication with the flow management system. The electrolyte management system is configured to regulate and maintain a temperature of the electrolyte flowing through the plurality of cells of the GMABS during the reaction.

According to one embodiment herein, a temperature control unit is operably coupled to the electrolyte management system. The temperature control unit is configured to control the temperature of the electrolyte flowing through the plurality of cells of the GMABS.

According to one embodiment herein, the electrolyte management system comprises one or more filters configured to purify and free the electrolyte from impurities that interfere with the reaction in the GMABS.

According to one embodiment herein, at least one of the plurality of auxiliary power sources is operably connected to the GMABS. The plurality of auxiliary power sources is selected from the group consisting of a metal ion battery, a lead acid battery, a nickel-cadmium battery, a redox flow battery, a supercapacitor, a nickel metal hydride battery, a zinc-bromine battery, a polysulfide-bromide battery, and any combination thereof. Any one of the plurality of auxiliary power sources is configured to receive the power from the GMABS when another one of the plurality of auxiliary power sources is discharged to a predefined SoC. Any one of the plurality of auxiliary power sources is configured to deliver the received power to components of the electric vehicle.

According to one embodiment herein, a single auxiliary power source is operably connected to the GMABS for receiving the power from the GMABS and delivering the received power to components of the electric vehicle. According to an embodiment herein, the system comprises a switching unit, in operable communication with the real-time monitoring and feedback system, for selectively switching between the plurality of auxiliary power sources for delivering the power to the components of the electric vehicle based on the computed SoC of each of the plurality of auxiliary power sources.

According to one embodiment herein, the real-time monitoring and feedback system comprises one or more feedback sensors configured to regulate a plurality of parameters comprising, for example, temperature, flow, power, energy, etc., within the electric vehicle. According to an embodiment herein, the system comprises a display unit operably coupled to the real-time monitoring and feedback system for projecting real-time values of the plurality of parameters regulated by the feedback sensors positioned in the real-time monitoring and feedback system.

According to one embodiment herein, the real-time monitoring and feedback system is configured to continuously compute and monitor a SoC of each of the plurality of auxiliary power sources in real time to facilitate a continuous delivery of the power to the components of the electric vehicle by any one of the plurality of auxiliary power sources, thereby extending the range of the electric vehicle.

According to one embodiment herein, the system comprises a regenerative braking system operably connected to the plurality of auxiliary power sources. The regenerative braking system is configured to recapture a kinetic energy of the electric vehicle for charging at least one of the plurality of auxiliary power sources during braking.

According to one embodiment herein, the system comprises one or more buffer tanks operably connected to the GMABS. The buffer tanks are configured to store additional quantities of the electrolyte and replenish the electrolyte in the plurality of cells of the GMABS to a predefined composition.

According to one embodiment herein, the system comprises a mechanical refuelling system configured to retract metal consumed during the reaction in the GMABS and insert units containing metal into the plurality of cells of the GMABS.

According to one embodiment herein, the system comprises a hydrogen harvesting system operably coupled to the GMABS. The hydrogen harvesting system is configured to collect and store a hydrogen gas produced during the reaction in the GMABS.

According to one embodiment herein, the hydrogen harvesting system comprises a hydrogen fuel cell configured to operate on the hydrogen gas and provide power for charging any one of the plurality of auxiliary power sources.

According to one embodiment herein, the system comprises a graphene-based air conditioning system configured to provide a desired air composition for an operation of the plurality of cells of the GMABS.

The embodiments herein also provide a method for extending a range of an electric vehicle as disclosed in the detailed description of FIG. 8.

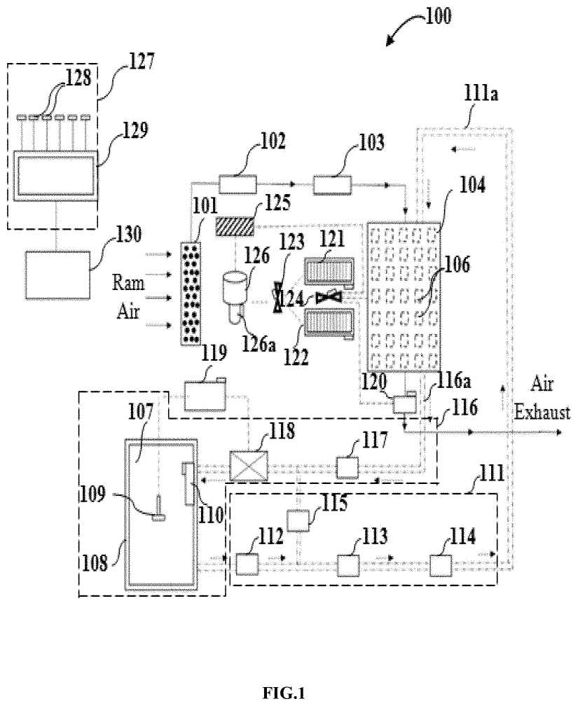

FIG. 1 illustrates a block diagram of a system 100 for extending a range of an electric vehicle using a graphene-based metal-air battery system (GMABS) 104, according to one embodiment herein. According to an embodiment herein, the system 100 comprises the GMABS 104, a flow management system 111, an electrolyte management system 116, one or more of a plurality of auxiliary power sources 121 and 122, and a real-time monitoring and feedback system 127. The GMABS 104 is an electrochemical battery comprising an anode made of a pure metal, for example, aluminium, zinc, lithium, iron, etc., and a cathode of ambient air or oxygen along with an electrolyte, for example, water. The anode of the GMABS 104 comprises graphene that enhance properties and performance of the anode. Graphene is an atomic-scale, two-dimensional hexagonal lattice made of a single layer of carbon atoms. Graphene is a strong, flexible, durable, and stable material and an optimal conductor of heat and electricity. The graphene in the anode of the GMABS 104 enhances the conductivity and large surface area traits of the material of the anode to achieve morphological optimization and performance. Graphene improves the energy density of the GMABS 104 and therefore using a GMABS 104 aids in extending the range of the electric vehicle. During discharging of the GMABS 104, a reduction reaction occurs in the ambient air cathode while the graphene-based metal anode is oxidized. According to an embodiment herein, the GMABS 104 comprises multiple cells 106. According to an embodiment herein, the cell count or the number of cells 106 in the GMABS 104 is in the range of 25 to 500. According to an embodiment herein, the cells 106 are arranged in a series configuration in the GMABS 104. According to another embodiment herein, the cells 106 are arranged in a parallel configuration in the GMABS 104. According to another embodiment herein, the cells 106 are arranged in a combination of a series configuration and a parallel configuration in the GMABS 104. The cells 106 are electrically connected to each other and are configured to be filled with an electrolyte for initiating a reaction in the GMABS 104 to generate power. The cells 106 of the GMABS 104 provide a combined power source that achieves an optimal combination of energy and power for maximum vehicle operational power output. The GMABS 104 is selected, for example, from an aluminium-air battery, a zinc-air battery, a lithium-air battery, an iron-air battery, etc. The GMABS 104 is a primary or main source of power for driving the electric vehicle.

The flow management system 111 is operably connected to the GMABS 104. The flow management system 111 regulates a circulation of the electrolyte in the GMABS 104. According to an embodiment herein, the flow management system 111 comprises one or more pumps, for example, 113, for controlling a flow of the electrolyte in the GMABS 104. The pumps 113 are, for example, diaphragm pumps, submersible pumps, centrifugal pumps, positive displacement pumps, hydraulic pumps, etc. The pumps 113 pump the electrolyte through the GMABS 104 for filling the cells 106 of the GMABS 104 and allow a controlled flow of the electrolyte in the GMABS 104. According to another embodiment herein, the flow management system 111 comprises one or more rotameters, for example, 114, integrated with one or more valves, for example, 112 and 115. The valves 112 and 115 are, for example, gate valves, solenoid valves, ball valves, etc. The rotameters 114 in operable communication with the valves 112 and 115 regulate a flow rate of the electrolyte. The rotameters 114 facilitate a uniform distribution of the electrolyte in the cells 106 of the GMABS 104 at a volumetric flow rate of, for example, about 1 litre per minute (LPM) to about 20 LPM.

According to one embodiment herein, the electrolyte management system 116 is in operable communication with the flow management system 111. The electrolyte management system 116 regulates and maintains a temperature of the electrolyte flowing through the cells 106 of the GMABS 104 in a range, for example, from about 10 degree Celsius to about 80 degree Celsius, during the reaction. According to an embodiment herein, the electrolyte management system 116 comprises a reservoir 107 configured as an electrolyte storage tank for storing the electrolyte. The electrolyte is circulated from the reservoir 107 to the GMABS 104 via a circulation pipe 111a, and from the GMABS 104 back to the reservoir 107 via a circulation pipe 116a. According to an embodiment herein, the system 100 provides a thermal insulation to each of the circulation pipes 111a and 116a. According to an embodiment herein, the electrolyte management system 116 further comprises a thermal insulation layer 108 that envelopes and thermally insulates the reservoir 107. Thermally insulating the reservoir 107 and the circulation pipes 111a and 116a increases the energy efficiency of the system 100. Since the system 100 requires a particular range of temperature for the optimal working of the GMABS 104, thermal insulation aids in conserving energy that otherwise would be lost during a heat exchange with the surrounding environment.

According to one embodiment herein, the electrolyte management system 116 further comprises a thermocouple 109 positioned in the reservoir 107 for measuring the temperature of the electrolyte contained within the reservoir 107. According to an embodiment herein, the electrolyte management system 116 further comprises one or more filters 110 for purifying and freeing the electrolyte from impurities that interfere with the reaction in the GMABS 104. The filters 110 are, for example, screen filters, disc filters, graphene-based filters, etc., or any combination thereof. The filters 110 filter the impurities that interfere with the reaction in the GMABS 104 by collecting spent metal during the operation of the GMABS 104 and at the end of each flow cycle. Continuous removal of the spent metal is required for an optimal working of the GMABS 104 since the spent metal hinders the undergoing half-cell reaction occurring at the metal electrodes in the GMABS 104. According to an embodiment herein, the electrolyte management system 116 further comprises a pump 117 for pumping the electrolyte from the GMABS 104 to the reservoir 107.

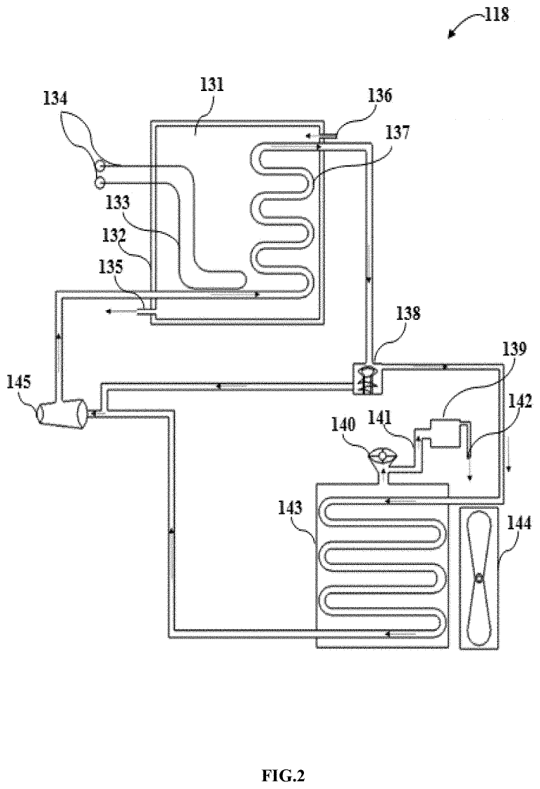

According to one embodiment herein, a temperature control unit 118, also referred to as a “heating-cooling system”, is operably coupled to the electrolyte management system 116. The temperature control unit 118 controls the temperature of the electrolyte flowing through the cells 106 of the GMABS 104 as disclosed in the detailed description of FIG. 2. According to an embodiment herein, the temperature control unit 118 comprises any one of a resistive heater, an inductive heater, a radiator, a fan, a coolant circulation system, or any combination thereof. The resistive heater, the inductive heater, and the radiator heat or increase the temperature of the electrolyte, while the fan and the coolant circulation system cool or decrease the temperature of the electrolyte, thereby allowing the temperature control unit 118 to control the temperature of the electrolyte flowing through the cells 106 of the GMABS 104. The temperature control unit 118 maintains the temperature of the electrolyte to a desired range, for example, from about 10 degree Celsius to about 80 degree Celsius. This range corresponds to a temperature window in which the efficiency of the GMABS 104 is maximum. According to an embodiment herein, the system 100 comprises a microcontroller 119 operably connected to the electrolyte management system 116 for controlling operations of the electrolyte management system 116.

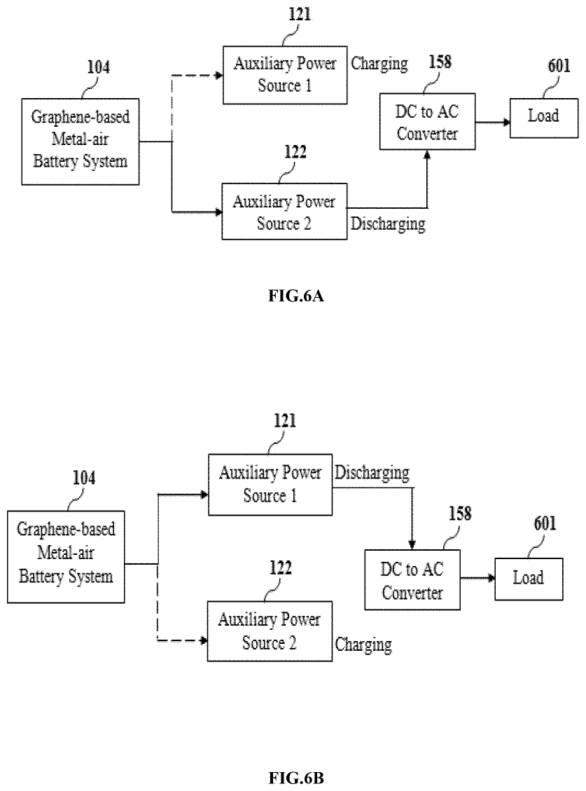

According to one embodiment herein, any one of the auxiliary power sources 121 and 122 is operably connected to the GMABS 104. That is, at any time, only one of the auxiliary power sources 121 and 122 is charged by the GMABS 104, which would later be used for powering the electric vehicle once the first auxiliary power source 121 is discharged to a set state of charge (SoC). The SoC is a level of charge of the auxiliary power source relative to its capacity. The auxiliary power sources 121 and 122 are selected from the group consisting of a metal ion battery, a lead acid battery, a nickel-cadmium battery, a redox flow battery, a supercapacitor, a nickel metal hydride battery, a zinc-bromine battery, a polysulfide-bromide battery, etc., or any combination thereof. The metal ion battery is, for example, a lithium-ion battery, a sodium-ion battery, a potassium-ion battery, etc. The redox flow battery is, for example, a vanadium redox battery. The connected auxiliary power source, for example, 121, receives power from the GMABS 104 when the other auxiliary power source, for example, 122, is discharged to a predefined SoC. The connected auxiliary power source 121 delivers the received power to components of the electric vehicle. Therefore, at any time, only one of the auxiliary power sources 121 and 122 delivers power to a motor 126 and electronics of the electric vehicle. According to an embodiment herein, a single auxiliary power source, for example, 121, is operably connected to the GMABS 104 for receiving the power from the GMABS 104 and delivering the received power to components of the electric vehicle as disclosed in the detailed description of FIGS. 6A-6B. According to an embodiment herein, the system 100 comprises a switching unit 124, in operable communication with the real-time monitoring and feedback system 127, for selectively switching between the auxiliary power sources 121 and 122 for delivering the power to the components of the electric vehicle based on the SoC of each of the auxiliary power sources 121 and 122. The switching unit 124 is an electronic circuit that controls switching between the auxiliary power sources 121 and 122.

According to an embodiment herein, the real-time monitoring and feedback system 127 comprises one or more feedback sensors 128 for regulating multiple parameters comprising, for example, temperature, flow, power, energy, etc., within the electric vehicle. According to an embodiment herein, the feedback sensors comprises thermocouples such as nickel-chromium thermocouples, nickel-alumel thermocouples, etc., for temperature sensing, drive shaft sensors for motor control, filtration sensors for monitoring a need to replace the filters 110 and flowmeters that control the flow of electrolyte through the system 100, etc. According to an embodiment herein, the system 100 comprises a display unit 130 operably coupled to the real-time monitoring and feedback system 127 for projecting real-time values of the parameters regulated by the feedback sensors 128. According to an embodiment herein, the real-time monitoring and feedback system 127 further comprises a data acquisition and compiler system 129 operably coupled to the feedback sensors 128 and the display unit 130 for processing data collected by the feedback sensors 128 and projecting real-time values of the parameters regulated by the feedback sensors 128 on the display unit 130. The feedback sensors 128 comprise, for example, direct and/or indirect variables, sensors, actuators, and associated control systems that provide data to the data acquisition and compiler system 129. The feedback sensors 128 measure and/or monitor parameters comprising, for example, voltage, current, and SoC of each of the auxiliary power sources 121 and 122, voltage and current of the GMABS 104, voltage of each of the cells 106 of the GMABS 104, flow rate and temperature of the electrolyte, etc. The feedback sensors 128 help in real-time monitoring of different parameters, for example, electrolyte temperature, flow rate, water level, etc., of the system 100. The real-time values of the parameters are displayed on the display unit 130 for an operator to view the operation of the GMABS 104.

The data collected by the feedback sensors 128 is transformed, processed, and executed by an algorithm in the data acquisition and compiler system 129. As the size of the collected data is large, the data acquisition and compiler system 129 prioritizes the data, generates a priority list for processing, and processes only the high priority data from respective feedback sensors 128. According to an embodiment herein, the priority list changes depending on the status of the switching unit 124 and the data acquisition and compiler system 129. The data acquisition and compiler system 129 executes the algorithm and generates multiple dynamic curves showing multiple real-time values, for example, temperature variation of the GMABS 104 with time and electrolyte flow, charging speed and charge level of the auxiliary power sources 121 and 122, etc. According to an embodiment herein, the real-time monitoring and feedback system 127 continuously computes and monitors a SoC of each of the auxiliary power sources 121 and 122 in real time to facilitate a continuous delivery of the power to the components of the electric vehicle by any one of the auxiliary power sources 121 and 122, thereby extending the range of the electric vehicle.

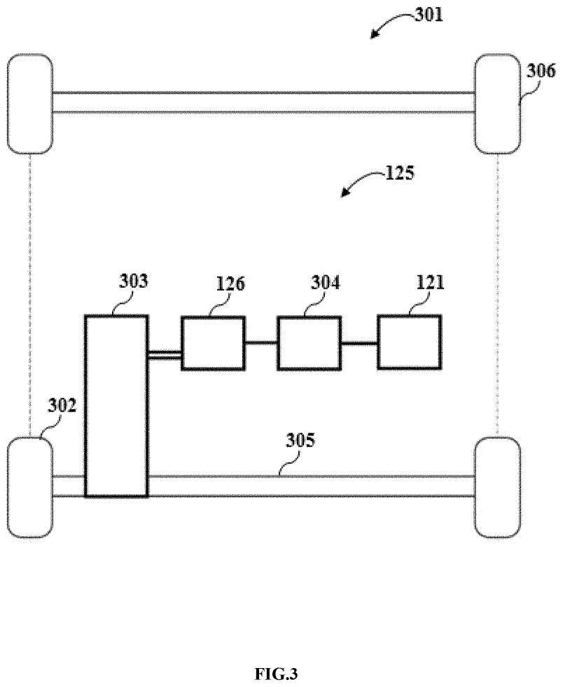

According to one embodiment herein, the system 100 comprises a regenerative braking system 125 operably connected to the auxiliary power sources 121 and 122. The regenerative braking system 125 provides an energy recovery mechanism that recovers, reuses, and/or stores kinetic energy generated by the electric vehicle during braking or slowing down of the electric vehicle. The regenerative braking system 125 recaptures a kinetic energy of the electric vehicle for charging at least one of the auxiliary power sources 121 and 122 during braking as disclosed in the detailed description of FIG. 3, which further enhances the efficiency of the system 100. The regenerative braking system 125 harnesses the energy generated during braking and utilizes this energy to charge the auxiliary power sources 121 and 122. According to an embodiment herein, the system 100 comprises a hydrogen harvesting system 120, also referred to as a “hybrid system”, operably coupled to the GMABS 104. The reaction of the electrolyte with the metal of the anode, for example, aluminium, of the GMABS 104 produces hydrogen gas as a by product. The hydrogen harvesting system 120 collects and stores the hydrogen gas produced during the reaction and/or the operation of the GMABS 104. According to an embodiment herein, the hydrogen harvesting system 120 comprises a hydrogen fuel cell that operates on the collected hydrogen gas and provides additional power for charging any one of the auxiliary power sources 121 and 122 being charged. According to an embodiment herein, the hydrogen harvesting system 120 comprises one or more suction pumps, compressors, pressure regulators, sensors, and special purpose hoses for safety and reliability. According to an embodiment herein, the hydrogen harvesting system 120 further comprises one or more tanks for storage and filtration of the hydrogen gas. According to an embodiment herein, the hydrogen harvesting system 120 stores hydrogen as a compressed gas state, a liquified hydrogen, or a solid hydride, and utilizes the stored hydrogen for additional power generation through fuel cells. According to an embodiment herein, the stored hydrogen is also used as a cooking fuel at homes or to power hythane vehicles. The hydrogen harvesting system 120 aids in further extending the range of the electric vehicle. The hydrogen harvesting system 120 feeds the generated power to a power system of the electric vehicle and thereby contributes towards extending the range of the electric vehicle.

Consider an example where the system 100 disclosed herein in installed in an electric vehicle. As illustrated in FIG. 1, ram air enters into the system 100 through a graphene-based metal scrubber 101 and flows through a flowmeter controller 102 and a dehumidifier 103. The graphene-based metal scrubber 101 filters and purifies the ram air. The flowmeter controller 102 measures and controls the flow rate of the purified ram air. According to an embodiment herein, the system 100 further comprises multiple gas flowmeters for maintaining an adequate air flow for the operation of the GMABS 104. The dehumidifier 103 removes moisture from the purified ram air. The graphene-based metal scrubber 101, the flowmeter controller 102, and the dehumidifier 103 maintain a specific air condition in the system 100 for the efficient operation of the GMABS 104. When the flow management system 111 fills the cells 106 of the GMABS 104 with the electrolyte from the reservoir 107 through the circulation pipe 111a to a predefined composition, the electrolyte initiates a reaction in the GMABS 104 to generate power. The hydrogen harvesting system 120 stores hydrogen gas evolved during the operation of the GMABS 104 and uses the hydrogen gas in a hydrogen fuel cell. Air exhaust exiting from the electric vehicle that runs on the system 100 disclosed herein comprises, for example, excess air and water vapours.

The GMABS 104 is operably connected to two auxiliary power sources 121 and 122. The switching unit 124 controls the power supply to charge the auxiliary power sources 121 and 122. Another electronic switching unit 123 controls the power supply to a shaft 126a of a motor 126 of the electric vehicle. The regenerative braking system 125 recaptures the kinetic energy of the electric vehicle during braking and uses the recaptured kinetic energy for charging the auxiliary power sources 121 and 122. The thermocouple 109 positioned in the reservoir 107 measures the temperature of the electrolyte contained in the reservoir 107. The series of filters 110 removes the spent metal from the incoming electrolyte that enters the reservoir 107 through the circulation pipe 116a. The valve 112 is a normally open valve that remains open during the operation of the pump 113 for the circulation of the electrolyte from the reservoir 107 to the GMABS 104. The rotameter 114 monitors and controls a flow of the electrolyte from the reservoir 107 to the GMABS 104. The pump 117 circulates the electrolyte from the GMABS 104 to the reservoir 107. The valve 115 is a normally closed valve that remains closed during the operation of the pump 113. The temperature control unit 118, in operable communication with the microcontroller 119, maintains the temperature of the electrolyte in a desired range. According to an embodiment herein, the feedback sensors 128 collect data from the hydrogen harvesting system 120, the auxiliary power sources 121 and 122, the switching unit 123, the shaft 126a of the motor 126, and the filters 110 and feed the data to the data acquisition and compiler system 129, which processes and projects the data on the display unit 130.

FIG. 2 illustrates the temperature control unit 118 incorporated in the system 100 shown in FIG. 1, according to one embodiment herein. The temperature control unit 118 maintains the temperature of the electrolyte flowing through the cells of the graphene-based metal-air battery system (GMABS) within a desired range. According to an embodiment herein, the temperature control unit 118 comprises a reservoir 131, a heating coil or heater 133 with electric terminals 134, an inlet valve 136, an outlet valve 135, a coolant tank 139, a pump 145, a cooling coil 137, a condenser 143 with a fan 144, a thermostat valve 138, a radiator cap 140, an expansion bleed pipe 141, and an overflow drain pipe 142. A thermal insulation layer 132 thermally insulates the reservoir 131. The heating coil or heater 133 heats the electrolyte to an optimum temperature for the operation of the GMABS. The electrolyte flows from the reservoir 131 to the GMABS through the outlet valve 135 and enters back into the reservoir 131 through the inlet valve 136. The coolant tank 139 contains a coolant that is circulated in the system 100 through the pump 145 and the cooling coil 137. The condenser 143 with the fan 144 decreases the temperature of the coolant. The thermostat valve 138, which opens at a desired temperature, regulates a flow of the coolant only after a predefined temperature is reached. As the temperature of the coolant increases, the coolant expands, thereby increasing a pressure in the coolant tank 139. The radiator cap 140 controls this expansion and provides a constant pressure in the temperature control unit 118. The expansion bleed pipe 141 and the overflow drain pipe 142 are included to prevent a leakage of the coolant.

FIG. 3 illustrates a block diagram of the regenerative braking system 125 incorporated in the system 100 shown in FIG. 1, according to one embodiment herein. The regenerative braking system 125 recaptures the kinetic energy of an electric vehicle 301 during braking. FIG. 3 illustrates a rear wheel 302 and a front wheel 306 of the electric vehicle 301, a gear box 303, the motor 126 operably connected to a motor controller 304, and an auxiliary power source 121 that is charged and thus stores the kinetic energy captured during the regenerative braking by a drive shaft 305 of the electric vehicle 301.

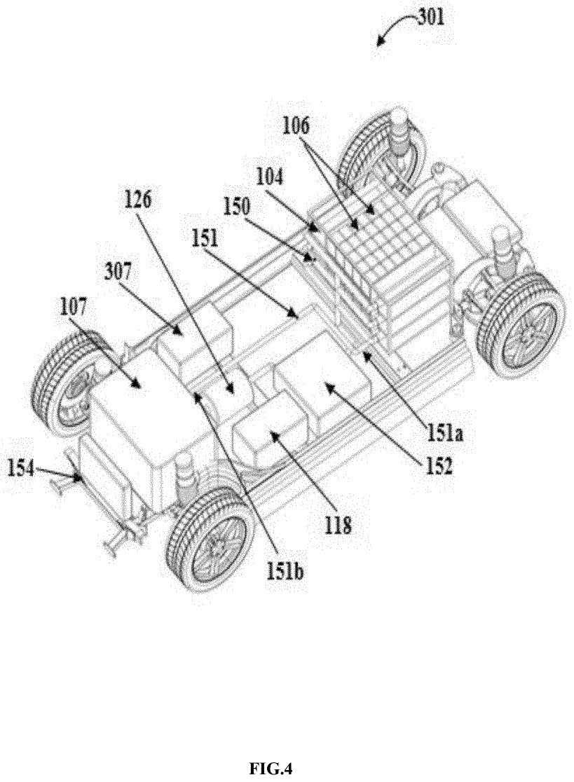

FIG. 4 illustrates a top perspective, cutaway view of an electric vehicle 301, showing an installation of the graphene-based metal-air battery system (GMABS) 104 and other components of the system 100 shown in FIG. 1, according to one embodiment herein. The electric vehicle 301 is, for example, an electric car, a battery electric vehicle, a plug-in electric vehicle, a plug-in hybrid electric-gasoline vehicle, etc. According to an embodiment herein, the flow management system 111 shown in FIG. 1, comprises one or more distribution channels 150 for distributing the electrolyte through the cells 106 of the GMABS 104. The distribution channels 150 are setup in the GMABS 104 for the flow of the electrolyte. The distribution channels 150 ensure a uniform distribution of the electrolyte within the GMABS 104, thereby maintaining a consistent power output from all the cells 106 in the GMABS 104. According to an embodiment herein, the flow management system 111 comprises an overflow management system 151 for preventing a leakage of the electrolyte inside the electric vehicle 301.

According to one embodiment herein, the distribution channels 150 along with the overflow management system 151 prevent a leakage of the electrolyte inside the electric vehicle 301. As illustrated in FIG. 4, the distribution channels 150 configured within the GMABS 104 are connected to the overflow management system 151. According to an embodiment, the overflow management system 151 is configured as a pipe comprising a first end 151a and a second end 151b. The first end 151a of the overflow management system 151 is connected to a distribution channel 150 for receiving the electrolyte that overflows from the GMABS 104. The second end 151b of the overflow management system 151 is connected to the reservoir 107 for transferring the overflowing electrolyte to the reservoir 107. According to an embodiment herein, the system 100 comprises a graphene-based air conditioning system 154 for providing a desired air composition for an operation of the cells 106 of the GMABS 104 by blocking the incoming carbon dioxide (CO₂) and allowing oxygen (O₂) to pass through. According to an embodiment herein, the graphene-based air conditioning system 154 is configured as a graphene-based air filter operably coupled to the reservoir 107 as illustrated in FIG. 4.

FIG. 4 also illustrates positions of the temperature control unit 118, a filtration tank 152, and the motor 126 and the electronics 307 of the electric vehicle 301 with respect to the GMABS 104. The filtration tank 152 filters and purifies the electrolyte circulated between the reservoir 107 and the GMABS 104. According to an embodiment herein, the system 100 comprises one or more buffer tanks in the reservoir 107 operably connected to the GMABS 104. The buffer tanks store additional quantities of the electrolyte and replenish the electrolyte in the cells 106 of the GMABS 104 to a predefined composition. The buffer tanks maintain electrolyte concentration in the cells 106 of the GMABS 104 to a predefined limit.

The reservoir 107 stores an electrolyte of an alkaline nature. The electrolyte is flown from the reservoir 107 through the stack of cells 106 of the GMABS 104 that are electrically connected to each other. Only when the electrolyte fills the cells 106, a reaction starts in which a metal, for example, aluminium, contained in the anode converts into a metal oxide while oxygen from the ambient air diffuses through the air cathode and reduces to hydroxide (OH−) ions, thereby generating power. The electrolyte management system, in communication with the temperature control unit 118, maintains the temperature of the electrolyte at an optimal range, for example, between about 10 degree Celsius and about 80 degree Celsius to increase efficiency of the reaction. A by product of this reaction is metal oxide particles, for example, aluminium oxide particles, that are retreated from the cells 106 of the GMABS 104 with the electrolyte flow. According to an embodiment herein, the electrolyte management system comprises filter cartridges that entrap the metal oxide particles and free the electrolyte from any metal oxide particle impurities that may interfere with the reaction.

The real-time monitoring and feedback system dynamically monitors concentration of the electrolyte in all the cells 106 of the GMABS 104 and uses the buffer tanks to replenish the electrolyte in the cells 106 to the desired composition. The kinetics of the reaction in the GMABS 104 and thereby the power generated from each of the cells 106 in the GMABS 104 is a direct function of the level to which the electrolyte is filled inside the cells 106. Through a set of flowmeters, valves, rotameters, etc., of the flow management system, the flow management system ensures that each of the cells 106 of the GMABS 104 is filled to a same level and hence the same power is generated from each of the cells 106. An optimum flow of the electrolyte through the cells 106 also leads to a uniform rate of metal dissolution, for example, aluminium dissolution, inside the cells 106.

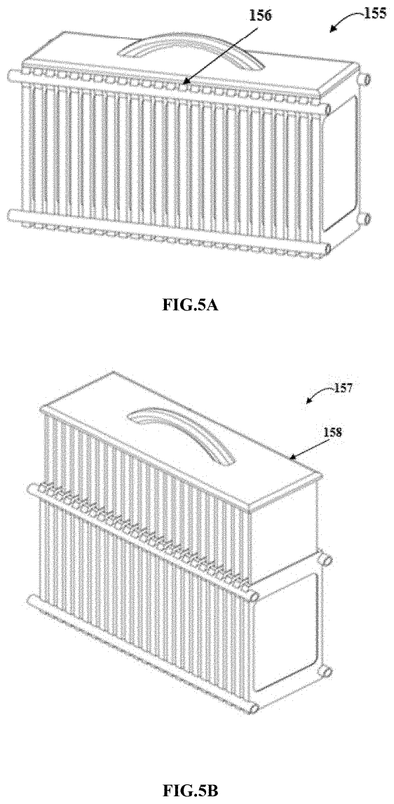

FIGS. 5A-5B illustrate perspective views of a mechanical refuelling system 155 and 157 incorporated in the system 100 shown in FIG. 1, according to an embodiment herein. According to an embodiment herein, the system 100 comprises a mechanical refuelling system 155 and 157 for retracting a metal consumed during the reaction in the GMABS and inserting units containing metal into the cells of the GMABS. For example, the mechanical refuelling system 155 and 157 allows a mechanical retraction of the consumed aluminium and insertion of multiple fresh aluminium cassettes into the cells of the GMABS in a single time. FIG. 5A illustrated a fully assembled battery stack 156, while FIG. 5B illustrates a mechanically removable cap with anodes 158 of the mechanical refuelling system 155 and 157 respectively.

FIGS. 6A-6B illustrate operations of the graphene-based metal-air battery system (GMABS) 104 in operable communication with two auxiliary power sources 121 and 122 for powering a load 601, according to one embodiment herein. The power generated by the GMABS 104 is used in multiple ways based on the number of auxiliary power sources implemented in the system disclosed herein. According to an embodiment herein, the system comprises two auxiliary power sources 121 and 122 operably coupled to the GMABS 104 as illustrated in FIGS. 6A-6B. At any time during the operation of the GMABS 104, power from the GMABS 104 is used to charge at least one auxiliary power source, for example, 121, while the other auxiliary power source, for example, 122, provides power to the load 601 as illustrated in FIG. 6A.

Since the GMABS 104 generates power in a direct current (DC) form, the system disclosed herein comprises a direct current (DC) to alternating current (AC) converter 158 for appliances that operate on AC power. The real-time monitoring and feedback system continuously monitors the state of charge (SoC) of the auxiliary power source 122, which relates to the amount of power left in the GMABS 104, and when the auxiliary power source 122 reaches a particular SoC, the switching circuit disconnects that auxiliary power source 122 from the GMABS 104 and the other auxiliary power source 121, which was being charged by the GMABS 104, provides power to the load 601 as illustrated in FIG. 6B, while the GMABS 104 charges the first auxiliary power source 122 that was discharged. This cycle continues until the whole system is turned off.

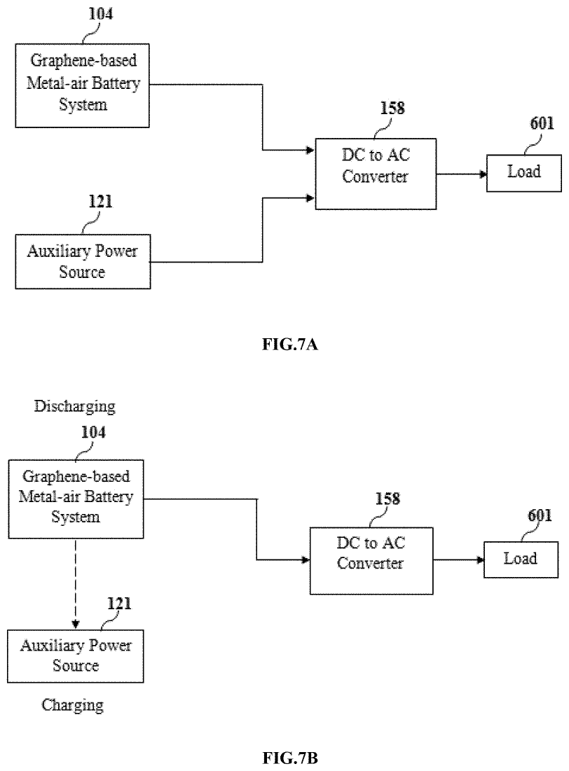

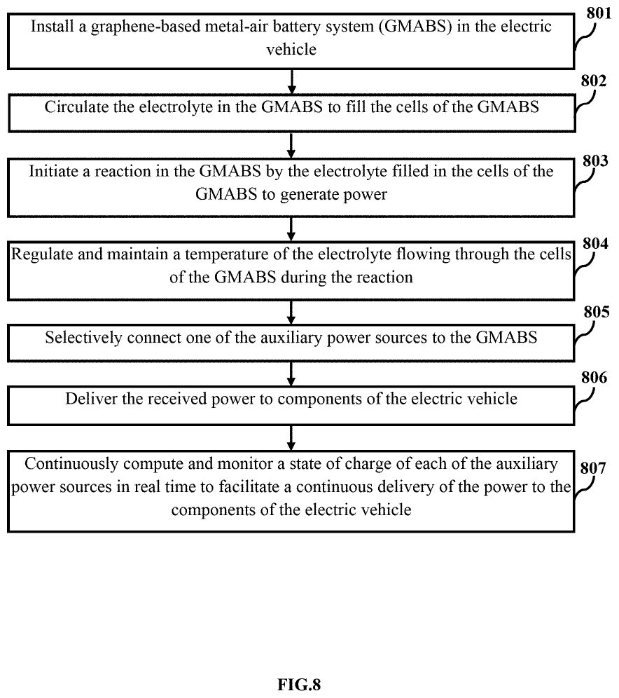

FIGS. 7A-7B illustrate operations of the graphene-based metal-air battery system (GMABS) 104 in operable communication with a single auxiliary power source 121 for powering a load 601, according to one embodiment herein. According to an embodiment herein, the system comprises a single auxiliary power source 121 operably coupled to the GMABS 104 as illustrated in FIGS. 7A-7B. With only one auxiliary power source 121, the GMABS 104 directly transfers the power to the load 601 as illustrated in FIG. 7A. When the required power is more than what the GMABS 104 is capable of providing, the auxiliary power source 121 meets the power requirement of the load 601 as illustrated in FIG. 7A. A direct current (DC) to alternating current (AC) converter 158 is operably coupled to the GMABS 104 and the auxiliary power source 121 for converting DC power to AC power for power transfer to the load 601. When the load 601 is less, additional power from the GMABS 104 is transferred to the auxiliary power source 121 for charging the auxiliary power source 121 as illustrated in FIG. 7B.

FIG. 8 illustrates a flowchart comprising the steps of the method for extending a range of an electric vehicle, according to one embodiment herein. In the method disclosed herein, a graphene-based metal-air battery system (GMABS) comprising multiple of cells as disclosed in the detailed description of FIG. 1, is installed 801 in the electric vehicle. The flow management system operably connected to the GMABS circulates 802 the electrolyte in the GMABS to fill the cells of the GMABS. The electrolyte filled in the cells of the GMABS initiates 803 a reaction in the GMABS to generate power. The electrolyte management system, in operable communication with the flow management system, regulates and maintains 804 a temperature of the electrolyte flowing through the cells of the GMABS during the reaction. The switching unit selectively connects 805 one of the auxiliary power sources to the GMABS to receive the power from the GMABS when another one of the auxiliary power sources is discharged to a predefined state of charge (SoC). The connected auxiliary power source delivers 806 the received power to components, for example, the motor and the electronics of the electric vehicle. The real-time monitoring and feedback system continuously computes and monitors 807 the SoC of each of the auxiliary power sources in real time to facilitate a continuous delivery of the power to the components of the electric vehicle by any one of the auxiliary power sources, thereby extending the range of the electric vehicle. Furthermore, in the method disclosed herein, the regenerative braking system, the buffer tanks, the mechanical refuelling system, the pumps and rotameters of the flow management system, the overflow management system, the temperature control unit, the filters of the electrolyte management system, the hydrogen harvesting system, and the graphene-based air conditioning system perform their respective functions as disclosed in the detailed descriptions of FIGS. 1-5B during the operation of the GMABS.

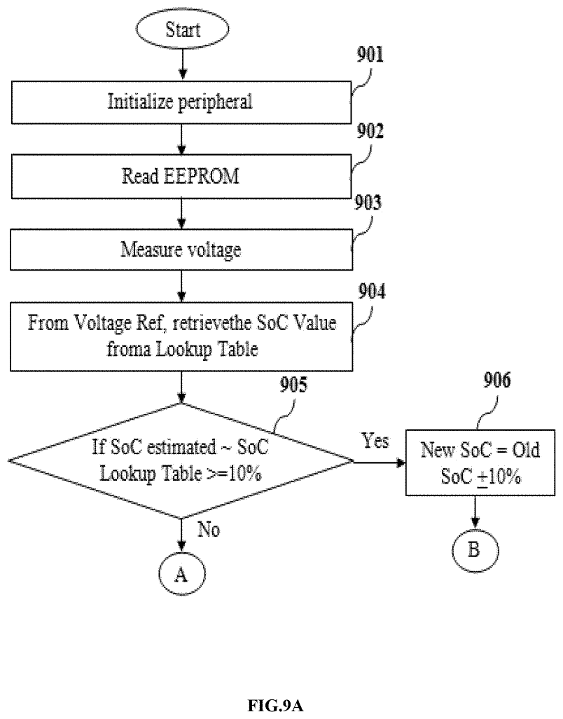

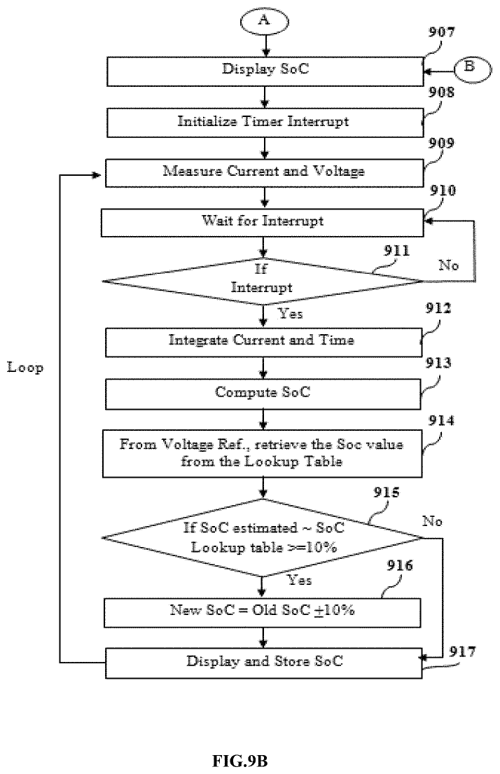

FIGS. 9A-9B illustrate a flowchart comprising the steps of a method implemented by the real-time monitoring and feedback system for computing a state of charge (SoC) of each of the auxiliary power sources of the system, according to an embodiment herein. According to an embodiment herein, the real-time monitoring and feedback system utilizes a coulomb counting method for measuring the SoC of each of the auxiliary power sources. The coulomb counting method measures a discharging current of a graphene-based metal-air battery system (GMABS) and integrates the discharging current over time for estimating the SoC. In the method disclosed herein, the real-time monitoring and feedback system initializes 901 a peripheral of the microcontroller of the system and reads 902 data stored in an electrically erasable programmable read-only memory (EEPROM). The real-time monitoring and feedback system measures 903 voltage and obtains a reference voltage. From the reference voltage, the real-time monitoring and feedback system retrieves 904 the SoC value from a lookup table. The real-time monitoring and feedback system determines 905 whether the estimated SoC value is equal to the SoC value stored in the lookup table or less than or equal to 10% of the SoC value stored in the lookup table. If the estimated SoC value is equal to the SoC value stored in the lookup table or less than or equal to 10% of the SoC value stored in the lookup table, the real-time monitoring and feedback system sets the new SoC value as equal to the old SOC value+10% of the SOC value stored in the lookup table, displays 907 the SoC value on the display unit, and initializes 908 a timer interrupt. If the estimated SoC value is not equal to the SoC value stored in the lookup table or less than or equal to 10% of the SoC value stored in the lookup table, the real-time monitoring and feedback system proceeds to display 907 the SoC value on the display unit.

The real-time monitoring and feedback system then measures 909a current and a voltage and waits 910 for the interrupt. If the real-time monitoring and feedback system does not receive the interrupt signal 911, the real-time monitoring and feedback system continues 910 to wait for the interrupt. If the real-time monitoring and feedback system receives the interrupt signal 911, the real-time monitoring and feedback system integrates 912 current and time. The real-time monitoring and feedback system then computes 913 the SoC value. From the reference voltage, the real-time monitoring and feedback system retrieves 914 the SoC value from the lookup table. The real-time monitoring and feedback system then determines 915 whether the estimated SoC value is equal to the SoC value stored in the lookup table or less than or equal to 10% of the SoC value stored in the lookup table. If the estimated SoC value is equal to the SoC value stored in the lookup table or less than or equal to 10% of the SoC value stored in the lookup table, the real-time monitoring and feedback system sets 916 the new SoC value as equal to the old SoC value+10% of the SoC value stored in the lookup table and displays and stores 917 the SoC value and repeats the loop from step 909. If the estimated SoC value is not equal to the SoC value stored in the lookup table or less than or equal to 10% of the SoC value stored in the lookup table, the real-time monitoring and feedback system displays and stores 917 the SoC value and repeats the loop from step 909.

While the range of most electric vehicles is, for example, about 100 km to about 150 km before they need to be recharged, the graphene-based metal-air battery system (GMABS) disclosed herein extends the range of the electric vehicle beyond 1000 km. During the operation of the GMABS, one of the auxiliary power sources is being continuously charged by the GMABS, while the other auxiliary power source is being discharged to provide a required power to run the electric vehicle. The functions of the auxiliary power sources are reversed once the discharging auxiliary power source reaches a particular state of charge (SoC). In this way, the high energy density of the GMABS allows the electric vehicles to cover long ranges on a single charge. Furthermore, the embodiments herein optimize a power generation reaction within the GMABS by purifying the electrolyte, uniformly distributing the electrolyte in the cells of the GMABS, replenishing the electrolyte, regulating a flow of the electrolyte within the GMABS, regulating and maintaining a temperature of an electrolyte flowing through cells of the GMABS, and replenishing metal contained in the GMABS.

The foregoing description of the specific embodiments will so fully reveal the general nature of the embodiments herein that others can, by applying current knowledge, readily modify and/or adapt for various applications such as specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the scope of the claims.

The foregoing examples and illustrative implementations of various embodiments have been provided merely for explanation and are in no way to be construed as limiting of the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

What is claimed is:

1. A system for extending a range of an electric vehicle, the system comprising:
a graphene-based metal-air battery system comprising a plurality of cells, wherein the plurality of cells is electrically connected to each other and configured to be filled with an electrolyte for initiating a reaction in the graphene-based metal-air battery system to generate power;
a flow management system operably connected to the graphene-based metal-air battery system, wherein the flow management system is configured to regulate a circulation of the electrolyte in the graphene-based metal-air battery system;
an electrolyte management system in operable communication with the flow management system, wherein the electrolyte management system is configured to regulate and maintain a temperature of the electrolyte flowing through the plurality of cells of the graphene-based metal-air battery system during the reaction;
at least one of a plurality of auxiliary power sources operably connected to the graphene-based metal-air battery system, wherein any one of the plurality of auxiliary power sources is configured to receive the power from the graphene-based metal-air battery system when another one of the plurality of auxiliary power sources is discharged to a predefined state of charge, and wherein the any one of the plurality of auxiliary power sources is configured to deliver the received power to components of the electric vehicle; and
a real-time monitoring and feedback system configured to regulate a plurality of parameters of the system and continuously compute and monitor a state of charge of each of the plurality of auxiliary power sources in real time to facilitate a continuous delivery of the power to the components of the electric vehicle by the any one of the plurality of auxiliary power sources, thereby extending the range of the electric vehicle.

2. The system according to claim 1, wherein the graphene-based metal-air battery system is selected from the group consisting of an aluminium-air battery, a zinc-air battery, a lithium-air battery, and an iron-air battery.

3. The system according to claim 1, comprising a regenerative braking system operably connected to the plurality of auxiliary power sources, wherein the regenerative braking system is configured to recapture a kinetic energy of the electric vehicle for charging the at least one of the plurality of auxiliary power sources during braking.

4. The system according to claim 1, comprising one or more buffer tanks operably connected to the graphene-based metal-air battery system, wherein the one or more buffer tanks are configured to store additional quantities of the electrolyte and replenish the electrolyte in the plurality of cells of the graphene-based metal-air battery system to a predefined composition.

5. The system according to claim 1, comprising a mechanical refuelling system configured to retract metal consumed during the reaction in the graphene-based metal-air battery system and insert units containing metal into the plurality of cells of the graphene-based metal-air battery system.

6. The system according to claim 1, wherein the flow management system comprises one or more pumps configured to control a flow of the electrolyte in the graphene-based metal-air battery system.

7. The system according to claim 1, wherein the flow management system comprises one or more rotameters integrated with one or more valves and configured to facilitate a uniform distribution of the electrolyte in the plurality of cells of the graphene-based metal-air battery system.

8. The system according to claim 1, wherein the flow management system comprises one or more distribution channels for distributing the electrolyte through the plurality of cells of the graphene-based metal-air battery system.

9. The system according to claim 1, wherein the flow management system comprises an overflow management system configured to prevent a leakage of the electrolyte inside the electric vehicle.

10. The system according to claim 1, comprising a temperature control unit operably coupled to the electrolyte management system, wherein the temperature control unit is configured to control the temperature of the electrolyte flowing through the plurality of cells of the graphene-based metal-air battery system.

11. The system according to claim 1, wherein the electrolyte management system comprises one or more filters configured to purify and free the electrolyte from impurities that interfere with the reaction in the graphene-based metal-air battery system.

12. The system according to claim 1, comprising a hydrogen harvesting system operably coupled to the graphene-based metal-air battery system, wherein the hydrogen harvesting system is configured to collect and store a hydrogen gas produced during the reaction in the graphene-based metal-air battery system, wherein the hydrogen harvesting system comprises a hydrogen fuel cell configured to operate on the hydrogen gas and provide power for charging the any one of the plurality of auxiliary power sources.

13. The system according to claim 1, comprising a graphene-based air conditioning system configured to provide a desired air composition for an operation of the plurality of cells of the graphene-based metal-air battery system.

14. The system according to claim 1, comprising a display unit operably coupled to the real-time monitoring and feedback system for projecting real-time values of the plurality of parameters regulated by one or more feedback sensors positioned in the real-time monitoring and feedback system, wherein the plurality of parameters comprises temperature, flow, power, and energy within the electric vehicle.

15. The system according to claim 1, comprising a switching unit, in operable communication with the real-time monitoring and feedback system, for selectively switching between the plurality of auxiliary power sources for delivering the power to the components of the electric vehicle based on the computed state of charge of the each of the plurality of auxiliary power sources.

16. The system according to claim 1, wherein the at least one of the plurality of auxiliary power sources is selected from the group consisting of a metal ion battery, a lead acid battery, a nickel-cadmium battery, a redox flow battery, a supercapacitor, a nickel metal hydride battery, a zinc-bromine battery, a polysulfide-bromide battery, and any combination thereof.

17. A method for extending a range of an electric vehicle, the method comprising steps of:
installing a graphene-based metal-air battery system in the electric vehicle, wherein the graphene-based metal-air battery system comprises a plurality of cells, and wherein the plurality of cells is electrically connected to each other;
circulating the electrolyte in the graphene-based metal-air battery system by a flow management system operably connected to the graphene-based metal-air battery system to fill the plurality of cells of the graphene-based metal-air battery system;
initiating a reaction in the graphene-based metal-air battery system by the electrolyte filled in the plurality of cells of the graphene-based metal-air battery system to generate power;
regulating and maintaining temperature of the electrolyte flowing through the plurality of cells of the graphene-based metal-air battery system during the reaction by an electrolyte management system in operable communication with the flow management system;
selectively connecting one of a plurality of auxiliary power sources to the graphene-based metal-air battery system by a switching unit to receive the power from the graphene-based metal-air battery system when another one of the plurality of auxiliary power sources is discharged to a predefined state of charge;
delivering the received power to components of the electric vehicle by the one of the plurality of auxiliary power sources; and
continuously computing and monitoring a state of charge of each of the plurality of auxiliary power sources in real time by the real-time monitoring and feedback system to facilitate a continuous delivery of the power to the components of the electric vehicle by any one of the plurality of auxiliary power sources, thereby extending the range of the electric vehicle.

18. The method according to claim 17, wherein the graphene-based metal-air battery system is selected from the group consisting of an aluminium-air battery, a zinc-air battery, a lithium-air battery, and an iron-air battery.

19. The method according to claim 17, comprises recapturing a kinetic energy of the electric vehicle by a regenerative braking system operably connected to the plurality of auxiliary power sources for charging the one of the plurality of auxiliary power sources during braking.

20. The method according to claim 17, comprises storing additional quantities of the electrolyte by one or more buffer tanks operably connected to the graphene-based metal-air battery system for replenishing the electrolyte in the plurality of cells of the graphene-based metal-air battery system to a predefined composition.

21. The method according to claim 17, comprises retracting metal consumed during the reaction in the graphene-based metal-air battery system and inserting units containing metal into the plurality of cells of the graphene-based metal-air battery system by a mechanical refuelling system.

22. The method according to claim 17, comprises controlling a flow of the electrolyte in the graphene-based metal-air battery system by one or more pumps of the flow management system.

23. The method according to claim 17, comprises facilitating a uniform distribution of the electrolyte in the plurality of cells of the graphene-based metal-air battery system by one or more rotameters integrated with one or more valves of the flow management system.

24. The method according to claim 17, comprises distributing the electrolyte through the plurality of cells of the graphene-based metal-air battery system by one or more distribution channels of the flow management system.

25. The method according to claim 17, comprises preventing a leakage of the electrolyte inside the electric vehicle by an overflow management system of the flow management system.

26. The method according to claim 17, comprises controlling the temperature of the electrolyte flowing through the plurality of cells of the graphene-based metal-air battery system by a temperature control unit operably coupled to the electrolyte management system.

27. The method according to claim 17, comprises purifying and freeing the electrolyte from impurities that interfere with the reaction in the graphene-based metal-air battery system by one or more filters of the electrolyte management system.

28. The method according to claim 17, comprises collecting and storing a hydrogen gas produced during the reaction in the graphene-based metal-air battery system by a hydrogen harvesting system operably coupled to the graphene-based metal-air battery system, wherein the hydrogen harvesting system comprises a hydrogen fuel cell configured to operate on the hydrogen gas and provide power for charging the one of the plurality of auxiliary power sources.

29. The method according to claim 17, comprises providing a desired air composition for an operation of the plurality of cells of the graphene-based metal-air battery system by a graphene-based air conditioning system installed in the electric vehicle.

30. The method according to claim 17, comprises regulating a plurality of parameters comprising temperature, flow, power, and energy within the electric vehicle by one or more feedback sensors positioned in the real-time monitoring and feedback system and projecting real-time values of the plurality of parameters on a display unit operably coupled to the real-time monitoring and feedback system.

31. The method according to claim 17, comprises selectively switching between the plurality of auxiliary power sources by the switching unit, in operable communication with the real-time monitoring and feedback system, for delivering the power to the components of the electric vehicle based on the computed state of charge of the each of the plurality of auxiliary power sources.

32. The method according to claim 17, wherein the one of the pluralities of auxiliary power sources is selected from the group consisting of a metal ion battery, a lead acid battery, a nickel-cadmium battery, a redox flow battery, a supercapacitor, a nickel metal hydride battery, a zinc-bromine battery, a polysulfide-bromide battery, and any combination thereof.
